(19) United States
(12) Patent Application Publication
(10) Pub. No.: US 2007/0286690 A1
(43) Pub. Date: Dec. 13, 2007

(54) Tire rasp drawknife and mounting therefore

(76) Inventor: Ricardo Daniel Perez, Provincia Buenos Aires (AR)

Correspondence Address: AMIN HALLIHAN, LLC, 217 N. JEFFERSON ST., SUITE 100, CHICAGO, IL, 60661, US

(21) Appl. No.: 11/811,555

(22) Filed: Jun. 11, 2007

(30) Foreign Application Priority Data
Jun. 12, 2006 (AR) P20060102471
Apr. 18, 2007 (AR) P20070101674

(51) Int. Cl. B23D 71/00

(52) U.S. Cl. 407/29.12; 407/29.13

(57) ABSTRACT

The mini drawknife body has one or more fixing openings which allow its assembly in the adjacency of the support periphery; from the notched rim, the body extends briefly right across until reaching such a width that the rim opposite to the notched rim cannot interfere with the openings and assembly bolts on the support. The invention also refers to an adaptation device for the assembly of the mini drawknife in a rotary support for tires roughing. This adaptation device comprises fixing sets integrated by bases and lateral retaining covers, among which intermediate separators can be placed; all these means have fixing members and openings which, in addition to forming jaws in the joint area, fasten to the roughing drawknives passing through some fastening openings of their body.

### FIELD OF THE INVENTION

This application claims the benefit of Argentina Patent Application No. P20060102471, filed Jun. 12, 2006, and Argentina Patent Application No. P200701-1674, filed Apr. 18, 2007.

The present invention refers to the field of different industrial techniques related to the work with plastic materials, particularly with tire retreading.

More particularly, it consists of a mini drawknife of peripheral assembly for superficial roughing which body is prepared to prevent the interference with the support bolts and for the assembly on the adjacency of the periphery of the supports by means of adaptation devices.

The invention also refers to an adaptation device of the assembly of the mini drawknife which fastening sets allow fastening the roughing drawknives firmly in the peripheral sector of the support.

### PRIOR ART

It is known that retreading is a process through which a worn out tire is renewed by means of placing a new tread on it. The purpose is to carefully remove the worn out tread and place a new tread on the buffed tire. Prior to this step in the process, a careful inspection of the tire is performed in order to check the tire is not damaged, which might affect its performance and safety on their main structure.

This inspection implies a careful examination of the tire looking for defects, on the inner part as well as on the outer part of the tire carcass. For that purpose, the tire can be inflated and checked if, upon reaching the normal use pressure, the tire maintains its structural integrity.

After this inspection, the deteriorated tread is removed by buffing it on a tire buffing machine. The buffing technique is simple since it is based on rotating the tire and contacting it with a cylindrical scraping device, which is rotating round in the opposite direction.

The scraping or roughing devices known are mounted on a rotary action support, among which plates or bodies, are some notched rasp blades or drawknives or sheets inserted into some assembly bolts.

The drawknives or rasp blades are separated from one another by separators, which are also inserted in the bolts of the rotary support, thus comprising a set. In this manner, the drawknives remain fixed to the support and with a certain separation between each other. Once the set is assembled, the support is closed with its cover and is placed on the buffing machine that makes it rotate to perform the tire scraping or buffing process.

On the other hand, during the tire buffing process—prior to retreading—large collision forces may occur due to the fact that the tires to be retreaded may contain foreign bodies, such as embedded nails or pieces of glass, which tend to engage the blade teeth of the buffering machine.

In order to cope with these efforts, the known prior art devices use drawknives which run through the bolts of the support, something that can be observed in the U.S. Pat. No. 4,021,899, U.S. Pat. No. 4,091,516, U.S. Pat. No. 5,054,177, U.S. Pat. No. 5,461,762 and U.S. Pat. No. 6,554,547.

As the drawknives have a really high cost, if their size were desirably reduced, the bolts of the support would have to be dangerously approached to their periphery or outer rim, thus weakening it and lowering the operative safety.

The function of the drawknives or rasp blades is to scrape the rubber from the tire carcass; therefore, they work acceptably when their teeth are maintained sharp. They stop cutting and are disposed of when their teeth suffer from a wear between 0.1 to 0.5 millimeters.

In addition, the efficacy of conventional drawknives is very low since, being pieces made of steel and having a tempering and artificial aging thermal treatment, only 0.2% of the total area of the piece is used. This should be added to the fact that a great part of the size of the drawknife is due to the need of fixation of its body to the supports.

Definitely, the devices known use drawknives of a relatively large size, mostly due to the need to fix them on the assembly support. Therefore, the assembly needs cause the use of a more expensive material which requires expenses in electric power and fuel used during the tempering and artificial aging thermal process.

### Advantages and Purposes

An objective of the present invention is to provide a mini drawknife or rasp blade smaller in size than the conventional drawknives.

Another objective is to provide a mini drawknife which does not need to be mounted on the support bolts and is prepared to be mounted on adaptation devices in the adjacency of the support periphery.

An objective of the present invention is to provide a device that allows reducing the size of the drawknives used.

The advantages of the present mini drawknife is the reduction of costs obtained through less use of drawknife material (about two and a half times less material than conventional drawknives) and the saving of energy (the electricity and fuels used yield more pieces per kilogram of thermal treatment) obtained in the manufacturing process of the mini drawknives.

Another advantage is the provision of a more efficient drawknife, multiplying almost 10 times the useful area in relation to the total area, if compared with the present technique level.

Another objective of the present invention is to provide a fastening adaptation device specific for the present mini drawknife.

An advantage of the present device is that it has a set, which allows firm fastening of the drawknife in the adjacency of the peripheral rim of the support.

Another advantage is that the fastening is not performed at the expense of safety as the fastening obtained is of maximum safety.

Another advantage is that smaller drawknives which size and weight are two and a half times more reduced than conventional drawknives are used.

Another advantage is the modular capacity and adaptation of the fastening sets that allows their use in supports of different sizes, regarding the diameters of their bodies as well as the measure and location of the assembly bolts. For that reason, the same drawknife can be used in:
Supports with small diameter differences between one another.
Supports which assembly bolts have different diameters (the drawknives known come already specifically prepared for bolts having 6 mm diameter or for bolts having 8 mm diameter).
Supports on which the bolts are arranged in another distance configuration between one another (All these differences are absorbed by the device).

Thus, the present drawknife becomes a universal application tool as it is prepared to work with adaptation assembly devices of the different types of existing supports.

Another advantage is that the pieces integrating the fastening set are all interrelated by means of fastening members and openings, which relate them immovably. This increases the strength of the set and also facilitates its assembly because at first, the support bolts to assemble the set can be omitted. Then, once the set of devices and drawknives is assembled, it is placed in the support.

### DRAWINGS

FIG. 1 is a front view, elevated of the present mini drawknife or rasp blade;

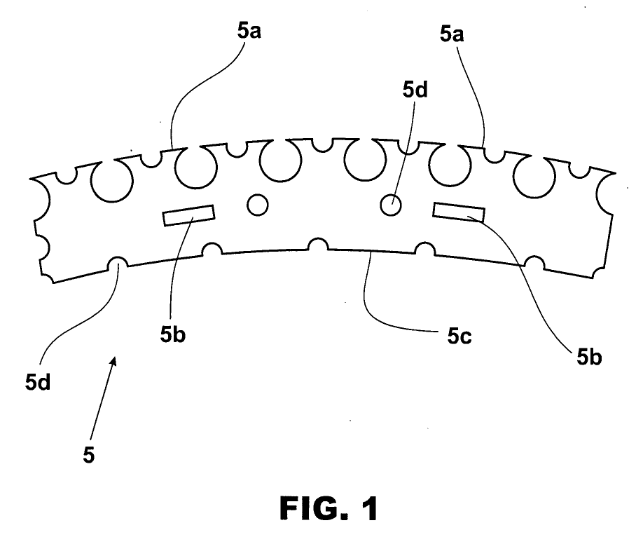

FIG. 2 is a perspective exploded view that allows appreciating the present mini drawknife in relation to the different parts integrating the fastening set of the adaptation device;

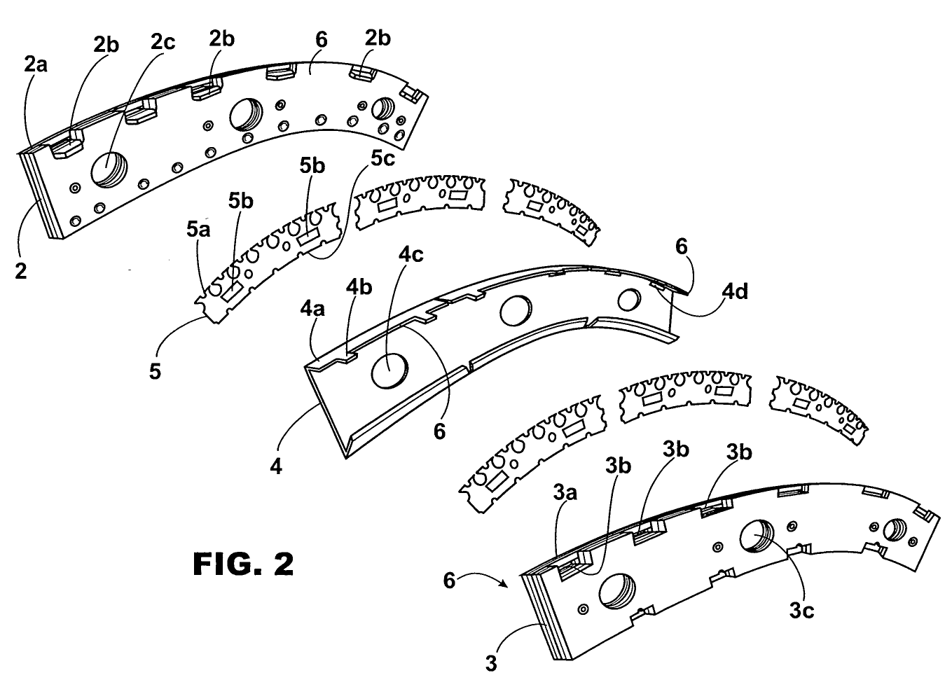

FIG. 3 is a perspective view of a fastening set assembled and ready to be placed in the support;

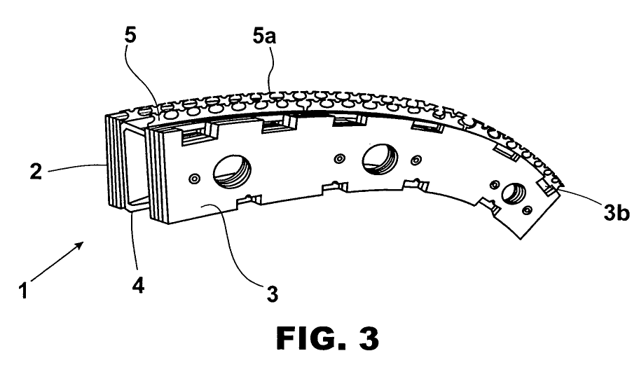

FIG. 4 shows two perspective views, which correspond to the posterior part of the intermediate separating mean and the lateral retaining cover;

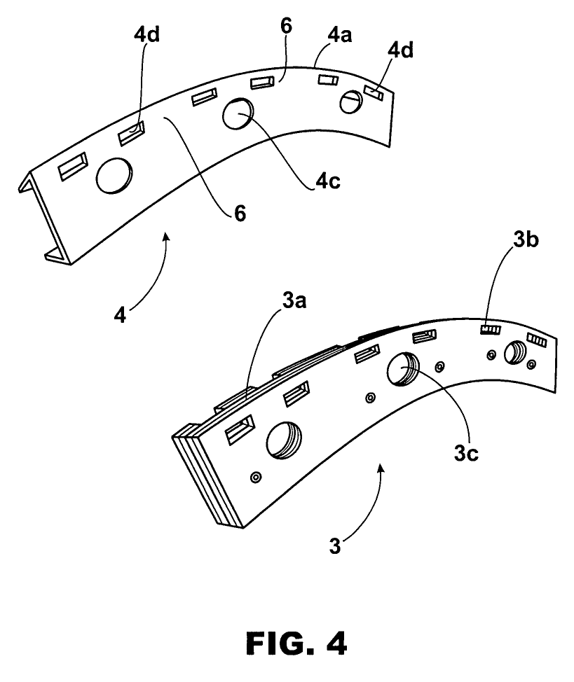

FIG. 5 is a lateral view, elevated, of a fastening set assembled where the arrangement of component parts can be appreciated;

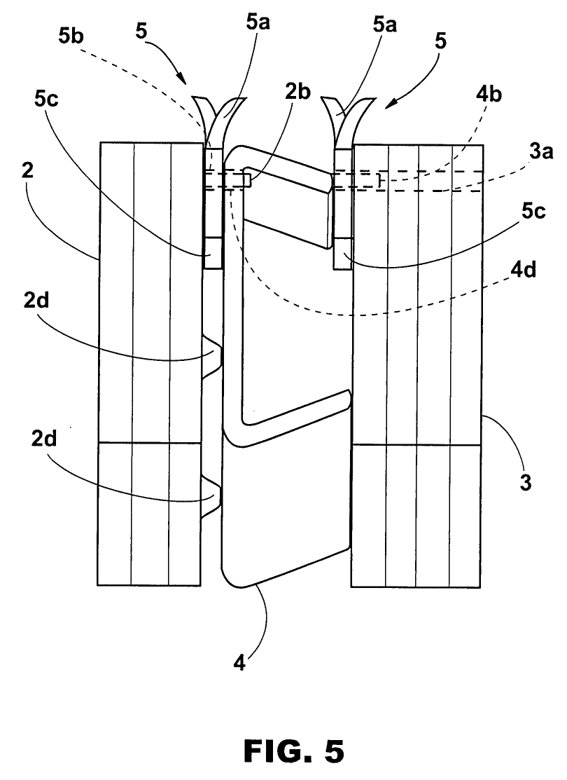

FIG. 6 is a perspective view of four fastening sets arranged in the same manner as when they are assembled on the lateral body of a support;

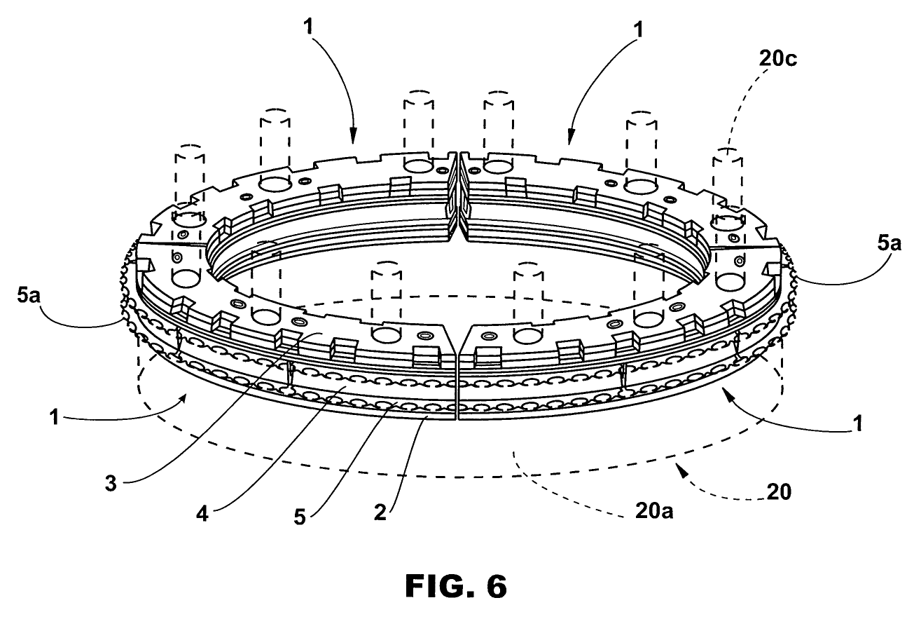

FIG. 6 is another perspective view similar to the view in FIG. 5, although, in this case two longer fastening sets are arranged, therefore, they can cover all the periphery of the support;

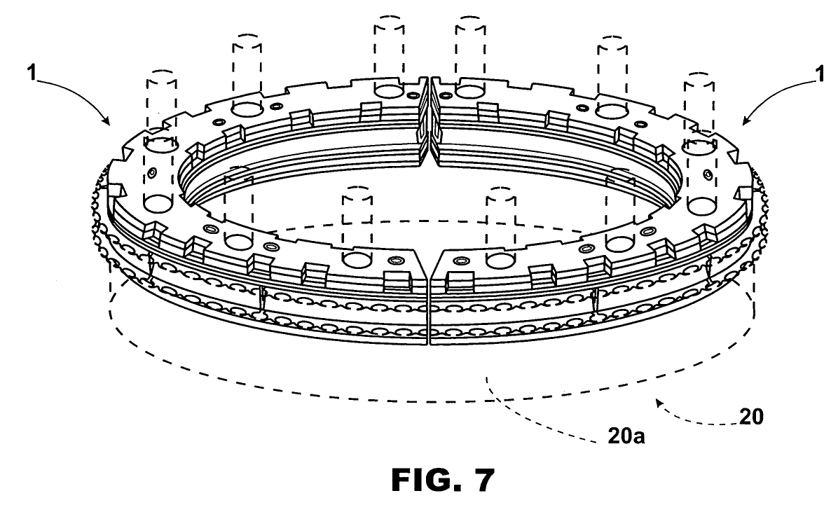

FIG. 7 is a lateral view, elevated, of several fastening sets mounted on a support and facing the tire area that has to be roughed; and

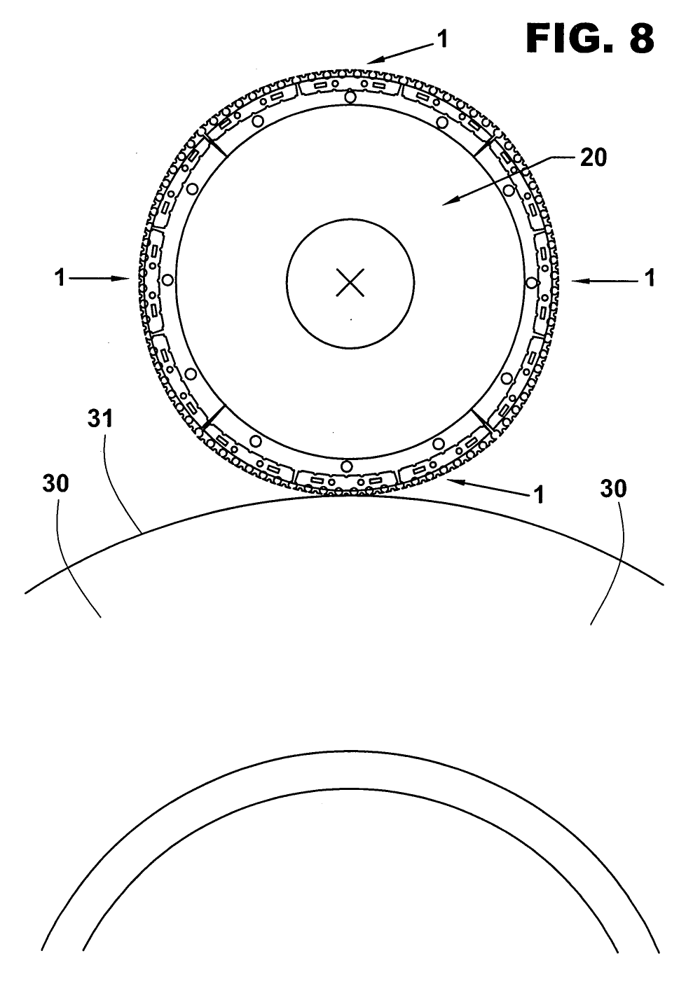

FIG. 8 is a perspective view of several fastening sets, all of them provided with a plurality of intermediate separators and drawknives. Through this configuration, the necessary width is obtained to produce the roughing of the tire tread, which appears facing.

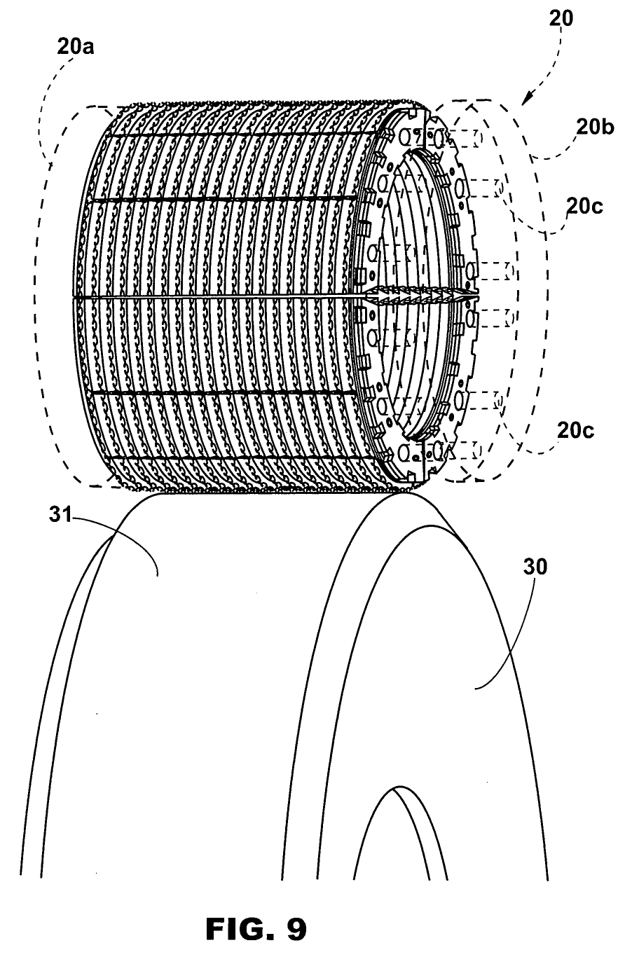

In the different figures, the same numbers and/or reference letters indicate equal or corresponding parts.
(1) Fastening set
(2) Lateral retaining base [lateral retaining mean].
(2a) First peripheral rim [of the lateral retaining base (2)]
(2b) First fastening members.
(2c) First assembly openings [in the bolts (20c) of the first body (20a) of the support (20)].
(2d) Supplementary projections.
(3) Lateral retaining cover [lateral retaining mean].
(3a) Second peripheral rim [of the lateral retaining cover (3)]
(3b) First fastening openings [on the lateral retaining cover (3)].
(3c) Second assembly openings [in the bolts (20c) of the first body (20a) of the support (20)].
(4) Intermediate separators.
(4a) Third peripheral rim [of the intermediate separators (4)]
(4b) Second fastening members [in the intermediate separators (4)].
(4c) Third assembly openings [in the bolts (20c) of the first body (20a) of the support (20)].
(4d) Second fastening openings [in the intermediate separators (4)].
(5) Mini drawknives or notched rasp blades [for roughing the tread (31) of the tire (30)].
(5a) Notching of the mini drawknives (5).
(5b) Third fastening openings [in the mini drawknives (5)].
(5c) Lower rim of the drawknives (5).
(5d) Openings and thinning down projections.
(6) Joint area [where the fastening jaws of the mini drawknives (5) are formed] (20) Support.
(20a) First lateral body of the support (20).
(20b) Second lateral body of the support (20).
(20c) Assembly bolts of the support (20).
(30) Application tire.
(31) Tread or roughing area of the tire (30).

### DESCRIPTION

In general terms, the present invention consists of a mini drawknife or rasp blade of peripheral assembly for superficial roughing which body has one or more fastening openings (5b) that allow its assembly in the adjacency of the support periphery (20); from the notched rim (5a), the body extends briefly all across until reaching such a width that the rim (5c) opposite to the notched rim (5a) does not interfere with the openings (2c)(3c)(4c) and assembly bolts (20c) of in the support (20). The invention also refers to an assembly adaptation device that, for the assembly in a rotary support (20) of tire roughing (30), comprises fastening sets (1) integrated by bases (2) and lateral retaining covers (3), among which intermediate separators (4) can be placed; all these means have fastening members (2b)(4b) and openings (3b)(3c)(4d) which, in addition to forming jaws in the joint areas (6), fasten the drawknives (5) of roughing going through the fastening openings (5b) of their body.

### DETAILED DESCRIPTION

More particularly, the present mini drawknife or rasp blade (5) comprises a body or notched blade, which notched rim (5a) produces the superficial roughing of the tie tread (31) (30) that is to be treaded later.

This mini drawknife (5) or notched blade more appropriate for the present device has a body that, from the notched rim (5a), extends briefly all across until reaching such a width that the opposite rim (5c) to the notched rim (5a) does not interfere with the openings (2c)(3c)(4c) and assembly bolts (20c) in the support (20).

However, the width of the drawknife (5) is enough to be inserted among the parts (2)(3)(4) of the fastening set (1), at the point where the fastening members are placed (2b)(4b). The latter can go through the body of the drawknives (5) thanks to the presence of third fastening openings (5b). In this manner, the drawknives (5) remain firmly and immovably fastened by the fastening set (1).

For the purpose of saving material and reducing the weight of the drawknife (5), it is provided the inclusion of openings and/or projections (5d), in the character of means for thinning out the material, independent from the above mentioned third fastening openings (5b).

### Adapting Device

More particularly, the present device belongs to the type of devices that is useful for the assembly of drawknives (5) or notched blades, by means of which the superficial roughing of the tread (31) of tires (30) to be treaded is performed.

The present device is prepared to be mounted in rotary supports (20), which, in general, are comprised by a set of lateral bodies (20a)(20b). In the middle of these first and second lateral bodies (20a)(20b) the mini drawknives (5) and their fastening elements are assembled. For the assembly of the support (20) there is a plurality of bolts (20c).

The present device comprises fastening sets (1) capable of fastening mini drawknives (5) of a small size in the adjacency of the peripheral rims (2a)(3a)(4a) of said sets (1).

Each fastening set (1) comprises a set of lateral retaining means (2)(3) and, optionally, it may comprise one or more intermediate separators (4).

The above mentioned set of lateral retaining means (2)(3) is comprised by a lateral retaining base (2) and a lateral retaining cover (3). The base (2) as well as the lateral retaining cover (3) has a curved configuration so that they can be arranged in the periphery of the bodies (20a)(20b) of the support (20), accompanying their circular shape.

In the present embodiment, the lateral retaining base (2) has some first assembly openings (2c), which allow inserting them into the bolts (20c) of the first lateral body (20a) of the support (20). Adjacent to the first peripheral rim (2a), it has a plurality of first fastening members (2b), which project as projections.

The lateral retaining cover (3) also has some second assembly openings (3c) for the bolts (20c) of the support (20). In the adjacency of the second peripheral rim (3a) it has some first fastening openings (3b).

To the effect of placing a larger quantity of mini drawknives (5) and obtaining the desired roughing width, there are intermediate separators (4). They possess third assembly openings (4c) in the support (20) and, in the adjacency of the third peripheral rim (4a), they possess second fastening members (4b) and second fastening openings (4d), arranged on opposite sides of the intermediate separators (4).

The parts (2)(3)(4) integrating the fastening set (1) admit different embodiments such as, being structured as solid pieces, set of pressed sheets, conformed profiles, etc.

Different embodiments have been considered. In one of them, the projected fastening members (2b)(4b) can be in the lateral bases (2) and in the intermediate separators (4), whereas the fastening or insert openings (4d)(3b) are in the intermediate separators (4) and the lateral cover (3). In another embodiment, the projected fastening members may be in the lateral cover (3) and in the intermediate separators (4), whereas the insert openings are in the intermediate separators (4) and in the lateral bases (2). A third embodiment has fastening members and openings intercalated in different parts of the fastening set (1).

In an embodiment, the projected fastening members (2b)(4b) are comprised by teeth, which insert in respective slots (3b)(4d) situated in the opposite part of the joint area (6) of the jaw. In another embodiment, the mentioned projected fastening members (2b)(4b) are comprised by pins, which insert in the corresponding openings.

Preferably, all these projected fastening members (2b)(4b) will be adjacent to the fastening (2a)(3a)(4a).

### Operation

The parts integrating (2)(3)(4) the fastening set (1) are arranged in a row with the inserted mini drawknives (5), so that the notching (5a) of the latter exceeds the peripheral rims (2a)(3a)(4a) of the fastening set (1).

The lateral retaining means (2)(3) as well as the intermediate separators (4) have joint areas (6) in which they join one another. In the assembly, these joint areas (6) comprise jaws in the middle of which the mini drawknives remain fastened (5). Besides, the fastening members (2b)(4b), which insert in the fastening openings (3b)(4d) that they face, pass the body of the mini drawknives (5) through the third fastening openings (5b). In this manner, a positional immovable fastening of the mini drawknives (5) and a firm fastening of them in the area adjacent to the peripheral rims are obtained (2a)(3a)(4a).

Although a set of lateral retaining means is enough (2)(3) to fasten a set of mini drawknives (5), usually, several intermediate separators (4) shall be used to assemble fastening sets (1) with several rows of mini drawknives (5) which provide an adequate roughing width, in relation to the length of the bolts (20c) of the support (20) on which they are assembled or the length of the axe of the machine which integrated the above mentioned support (20).

In addition, as the lateral retaining means (2)(3) and the intermediate separators (4) have a plurality of members (2b)(4b) and fastening openings (3b)(4d), the latter act as a guide of assembly and positional fastening into the fastening set (1). On the other hand, different length fastening sets (1) have been considered, so that one or several mini drawknives may be included (5) aligned in each joint area (6). In addition, this different length allows the change in the amount of fastening sets (1) necessary to cover the periphery of the support (20).

Undoubtedly, upon putting the present invention into practice, modifications may be introduced regarding certain construction details and form, without leaving the essential principles that are clearly explained in the claims below:

I claim:

1. A mini drawknife member which is structurally arranged with similar drawknife members and positioned to engage the tire area to be retreaded to produce the superficial roughing of said tire area, is rotatively driven by a machine which support provides assembly by means of a set of support pieces and bolts, among which there is an adaptation device which provides fastening in the adjacency of the periphery of said support pieces, said drawknife comprising:
a body comprised by an arched blade;
said body presenting two opposite longitudinal arched rims which comprise an inner rim and a notched outer rim; wherein
said body is arranged in the adjacency of the periphery of the support without reaching the position of the bolts; and
said body comprises at least a fastening opening prepared to be crossed by a fastening member provided by the application adaptation device.

2. The mini drawknife in accordance with claim 1, wherein said fastening opening comprises a set of fastening openings prepared to be passed through by each fastening member provided by the application adaptation device.

3. The mini drawknife in accordance with claim 1, wherein the length of the arched body is shorter than the length of the adaptation device so that at least, two aligned units per each fastening set of the adaptation can be placed therein.

4. The mini drawknife in accordance with claim 1, wherein said body includes openings and/or projections that, in the character of means for thinning the material, are independent from said fastening openings.

5. A tire buffing machine for mounting drawknives for buffing a tire carcass, which comprises:
a support member;
at least a fastening set for the drawknives prepared to be mounted in the adjacency of the periphery of said support member;
said fastening set, at least, a set of lateral retaining means provided with assembly means in the support and optionally, one or more intermediate separators capable of inserting between said lateral retaining means;
the joint area between said retaining means and said intermediate separators comprise each corresponding fastening jaws for drawknives; and
said jaws comprise fastening members which go through said drawknives to mount said drawknife to said support member.

6. The machine in accordance with claim 5, which comprises, at least, a set of retaining means provided with a plurality of intermediate separators.

7. The machine in accordance with claim 5, which comprises a plurality of sets of lateral retaining means provided with respective intermediate separators, each set being arranged in a different angular position on the support, in such an arrangement that they provide jaws for the drawknives in all the periphery of said supports.

8. The machine in accordance with claim 5, wherein the lateral retaining means includes a lateral base and a lateral cover.

9. The machine in accordance with claim 5, wherein the projected fastening members have respective insert openings provided on the opposite rim of the joint area.

10. The machine in accordance with claim 9, wherein the projected fastening members are in the lateral base and in the intermediate separators and the insert openings are in the intermediate separators and in the lateral cover.

11. The machine in accordance with claim 9, wherein the projected fastening members are in the lateral cover and the intermediate separators, whereas the insert openings are in the intermediate separators and in the lateral base.

12. The machine in accordance with claim 5, wherein the projected fastening members are comprised by a set of teeth which insert into each slot situated on the opposite part of the joint area of the jaw.

13. The machine in accordance with claim 5, wherein the projected fastening members are comprised by a set of pins which insert into each opening situated on the opposite part of the joint area of the jaw.

14. The machine in accordance with claim 5, wherein the projected fastening members are adjacent to the peripheral rim of the fastening set.

15. The machine in accordance with claim 5, wherein the fastening members act as guides of assembly of the fastening set.
